(19) United States
(12) Patent Application Publication
(10) Pub. No.: US 2026/0153865 A1
(43) Pub. Date: Jun. 4, 2026

(54) INFORMATION PROCESSING METHOD, INFORMATION PROCESSING DEVICE, AND COMPUTER PROGRAM PRODUCT

(71) Applicant: Panasonic Intellectual Property Management Co., Ltd., Osaka (JP)

(72) Inventors: Motoshi ANABUKI, Hyogo Ken (JP); Yuta SHIMOTSUMA, Osaka Fu (JP)

(73) Assignee: Panasonic Intellectual Property Management Co., Ltd., Osaka (JP)

(21) Appl. No.: 19/457,957

(22) Filed: Jan. 23, 2026

Related U.S. Application Data
(63) Continuation of application No. PCT/JP2025/006416, filed on Feb. 25, 2025.
(60) Provisional application No. 63/718,024, filed on Nov. 8, 2024.

(51) Int. Cl. G05D 1/227; G05D 1/226; G05D 1/617; G05D 109/10; G05D 111/30

(52) U.S. Cl. CPC G05D 1/2274; G05D 1/226; G05D 1/617; G05D 2109/10; G05D 2111/32

(57) ABSTRACT

An information processing method according to the present disclosure is executed by an information processing system configured to support remote control of at least one autonomous moving body by an operator. The information processing method includes: by an operator side of the information processing system, when acquiring an operation instruction to start remote monitoring, transitioning from a viewing mode in which the operator is not responsible for control to a monitoring mode in which the operator is responsible for control and enabling input of an operation instruction of a remote operation for remotely controlling a target moving body that is a target of the remote monitoring among the at least one autonomous moving body; and when acquiring an operation instruction to end the remote monitoring, transitioning from the monitoring mode to the viewing mode and disabling the input of the operation instruction of the remote operation.

### CROSS-REFERENCE TO RELATED APPLICATIONS

This application is a continuation of International Application No. PCT/JP2025/006416, filed on Feb. 25, 2025 which claims the benefit of priority of U.S. 63/718,024, filed on Nov. 8, 2024, the entire contents of which are incorporated herein by reference.

### FIELD

The present disclosure relates to an information processing method, an information processing device, and a computer program product.

### BACKGROUND

In recent years, introduction of automatic driving mobility has been promoted in various places such as public roads, factories, airports, and harbors in order to solve manpower shortage. Under such circumstances, it is very difficult to realize completely unmanned operation without human hand intervention from the viewpoint of safety, and intervention by a remote person becomes necessary at the time of occurrence of hazard or abnormality.

For example, Patent Literature 1 discloses a technology for enabling appropriate operation of a plurality of moving bodies to be remotely monitored regarding a moving body such as a bus operated by an automatic driving technology.

A related technology is disclosed in Japanese U.S. Pat. No. 6,980,609.

However, in remote control for automatic driving mobility, in a case where an operator remotely gives an operation instruction, if an unintended instruction is performed due to, for example, a system malfunction, a processing delay, or a communication delay, safety may be reduced.

The present disclosure has been made in view of the above, and it is an object to improve safety of remote control for automatic driving mobility.

### SUMMARY

An information processing method according to the present disclosure is an information processing method executed by an information processing system configured to support remote control of at least one autonomous moving body by an operator. The information processing method includes: by an operator side of the information processing system, when acquiring an operation instruction to start remote monitoring, transitioning from a viewing mode in which the operator is not responsible for control to a monitoring mode in which the operator is responsible for control and enabling input of an operation instruction of a remote operation for remotely controlling a target moving body that is a target of the remote monitoring among the at least one autonomous moving body; and when acquiring an operation instruction to end the remote monitoring, transitioning from the monitoring mode to the viewing mode and disabling the input of the operation instruction of the remote operation.

### BRIEF DESCRIPTION OF THE DRAWINGS

FIG. 1 is a diagram illustrating an example of a schematic configuration of a remote control system according to an embodiment;

FIG. 2 is a diagram illustrating an example of a schematic configuration of each device included in the remote control system according to the embodiment;

FIG. 3 is a diagram illustrating an example of a hardware configuration of an information processing device that implements each function of each device included in the remote control system according to the embodiment;

FIG. 4 is a flowchart illustrating an example of a flow of starting an operation of remote monitoring in the remote control according to the embodiment;

FIG. 5 is a flowchart illustrating an example of a flow of the operation of remote monitoring in the remote control according to the embodiment;

FIG. 6 is a flowchart illustrating an example of a flow of ending an operation of remote monitoring in the remote control according to the embodiment;

FIG. 7 is a flowchart illustrating an example of a flow of processing during automatic traveling in the remote control according to the embodiment;

FIG. 8 is a diagram illustrating an example of the screen display of the operator terminal in the remote control according to the embodiment;

FIG. 9 is a diagram illustrating another example of the screen display of the operator terminal in the remote control according to the embodiment;

FIG. 10 is a sequence diagram illustrating an example of a flow of information processing at the start of remote monitoring executed by each unit of the remote control system according to the embodiment;

FIG. 11 is a sequence diagram illustrating an example of a flow of information processing related to communication delay monitoring at the time of performing remote monitoring, executed by each unit of the remote control system according to the embodiment;

FIG. 12 is a sequence diagram illustrating an example of a flow of information processing related to an operation instruction by an operator at the time of performing remote monitoring, executed by each unit of the remote control system according to the embodiment;

FIG. 13 is a sequence diagram illustrating an example of a flow of information processing at the end of remote monitoring executed by each unit of the remote control system according to the embodiment;

FIG. 14 is a sequence diagram illustrating another example of a flow of information processing at the start of remote monitoring executed by each unit of the remote control system according to the embodiment;

FIG. 15 is a sequence diagram illustrating another example of a flow of information processing at the start of remote monitoring executed by each unit of the remote control system according to the embodiment; and

FIG. 16 is a diagram illustrating another example of the screen display of the operator terminal in the remote control according to the embodiment.

### DETAILED DESCRIPTION

Hereinafter, embodiments of an information processing method, an information processing device, an information processing system, a moving body, a program, and a recording medium according to the present disclosure will be described in detail with reference to the accompanying drawings.

In the description of the present disclosure, components having the same or substantially the same functions as those described above with respect to the previously described drawings are denoted by the same reference numerals, and the description thereof may be appropriately omitted. In addition, even in the case of representing the same or substantially the same portion, the dimensions and ratios may be represented differently from each other depending on the drawings. Furthermore, for example, from the viewpoint of ensuring visibility of the drawings, in the description of each drawing, only main components are denoted by reference numerals, and even components having the same or substantially the same functions as those described above in the previous drawings may not be denoted by reference numerals.

Note that in the description of the present disclosure, constituent elements having the same or substantially the same function may be distinguished and described by adding alphanumeric characters and/or symbols to the end of the reference numerals. Alternatively, in a case where a plurality of components having the same or substantially the same function are not distinguished, alphanumeric characters and/or symbols added to the end of the reference numerals may be omitted and integrated.

In the present disclosure, “remote control” is classified into three modes of “remote viewing”, “remote assistance”, and “remote maneuvering” in which the responsibility, the possible operation, the safety function activation condition, and the like are different depending on the form of control with respect to the target moving body. Here, the “remote control” is at least any of “remote viewing”, “remote assistance”, and “remote maneuvering” with respect to at least one moving body configured to move autonomously and to be able to execute a predetermined task.

In the present disclosure, “remote viewing” is a remote control mode in which moving body information regarding at least one target moving body or a surrounding environment thereof is presented to an operator so as to be remotely viewed (confirmed) or viewed (confirmed) by the operator. The moving body information is information from various sensors mounted on the moving body, such as a camera video of a camera mounted on the moving body, sensing information generated by processing the information, and/or information representing a state of the moving body itself, such as a vehicle speed. Furthermore, the operator is a person who remotely monitors a moving body such as a vehicle and performs a work of remotely operating the moving body as necessary. Here, the “remote viewing” is an example of a remote control mode for remotely monitoring at least one target moving body by transmitting moving body information such as an image related to the target moving body.

Furthermore, in the present disclosure, “remote assistance” means, in addition to “remote viewing”, remotely instructing (remotely operating) control of the target moving body by transmitting a control signal (travel instruction signal) corresponding to an operation instruction with respect to a target moving body among at least one moving body. The operation instruction means that the operator remotely instructs the operation of the moving body of automatic driving such as the start or stop of the automatic traveling of the moving body, but the operation instruction may also include an instruction related to a minimal risk maneuver (MRM) including an emergency stop or an operation not related to traveling. The MRM will be described later. Here, the “remote assistance” is an example of a first transmission mode for controlling a target moving body by a control signal transmitted as a single instruction request.

Furthermore, in the present disclosure, “remote maneuvering” refers to remotely controlling (remotely operating) a target moving body by transmitting a control signal (maneuvering signal) corresponding to an operation instruction with respect to the target moving body among at least one moving body. Here, the “remote maneuvering” is an example of a second transmission mode for controlling a target moving body by a control signal transmitted as a continuous instruction request.

The display on a User Interface (UI) includes display of moving body information and surrounding environment information in each of the remote control modes of “remote viewing”, “remote assistance”, and “remote maneuvering”.

The control responsibility of the operator is “none” in the remote control mode of “remote viewing”, and is “present” in each of the remote control modes of “remote assistance” and “remote maneuvering”.

The operation (remote operation) that can be performed by the operator is “none” in the remote control mode of “remote viewing”, and is “present” in each of the remote control modes of “remote assistance” and “remote maneuvering”. For example, the operation that can be performed by the operator in the remote control mode of “remote assistance” includes an operation of command transmission of safe stop, automatic travel stop, automatic travel restart, and route change of the moving body. For example, the operation that can be performed by the operator in the remote control mode of “remote maneuvering” includes vertical control such as operation of an accelerator or a brake of the moving body and lateral control such as operation of steering (e.g., steering operation).

The simultaneous control restriction is “none” in the remote control mode of “remote viewing”, and is “present” in each of the remote control modes of “remote assistance” and “remote maneuvering”. For example, the simultaneous control restriction in each of the remote control modes of “remote assistance” and “remote maneuvering” is that there is only one operator who can be in the form of “remote assistance” or “remote maneuvering” with respect to one vehicle.

The safety function activation condition is “none” in the remote control mode of “remote viewing”, and is “present” in each of the remote control modes of “remote assistance” and “remote maneuvering”. For example, the safety function activation condition in each of the remote control modes of “remote assistance” and “remote maneuvering” is that the transmission display function of the video and the vehicle information is correctly operated without delay and/or that the transmission and execution of the instruction command can be correctly performed without delay.

As described above, in the “remote control” of the present disclosure, in the “remote assistance” and the “remote maneuvering”, it is possible to lower the level of automatic driving of the moving body instead of the operator being responsible for control. That is, at the time of “remote assistance” and “remote maneuvering” in the “remote control” of the present disclosure, the remote system ensures that the operator can fulfill the control responsibility.

Note that, in the present disclosure, the remote control mode of “remote viewing” may be simply described as “viewing mode”. Furthermore, in the present disclosure, the respective remote control modes of “remote assistance” and/or “remote maneuvering” may be integrated and described as “remote monitoring” or “monitoring mode”. Therefore, this “remote monitoring” means that the operator remotely monitors the state of the moving body by moving body information (video and various information) and remotely controls the target moving body by an operation instruction of a remote operation as necessary. That is, in the present disclosure, the “viewing mode” is a remote control mode in which the operator is not responsible for control, and the “monitoring mode” is a remote control mode in which the operator is responsible for control.

Note that in the present disclosure, operating in each mode of “remote viewing”, “remote assistance”, and “remote maneuvering” may be described as “(remote) viewing state”, “(remote) assistance state”, and “(remote) maneuvering state”, respectively. In addition, operating in the “monitoring mode” may be described as “(remote) monitoring state”.

### Configuration Example of Remote Control System

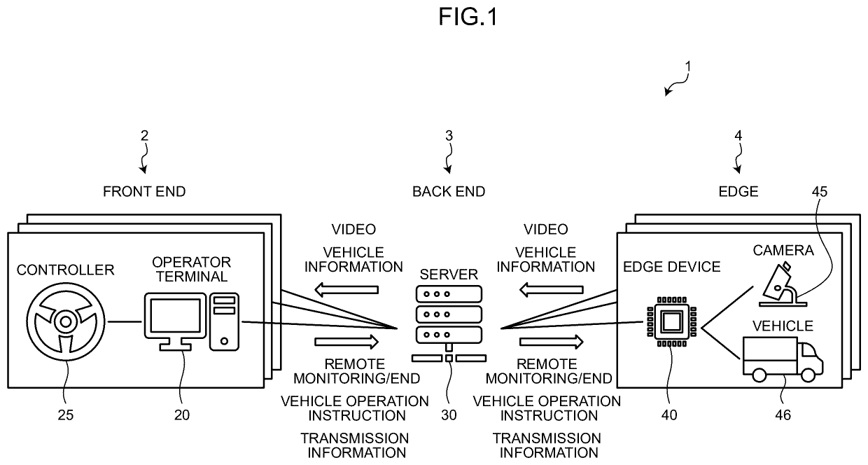

FIG. 1 is a diagram illustrating an example of a schematic configuration of a remote control system 1 according to an embodiment. As illustrated in FIG. 1, the remote control system 1 includes a front end 2, a back end 3, and an edge 4.

In the remote control system 1, a plurality of the front ends 2 and a plurality of the edges 4 are connected to the back end 3. In the remote control system 1, a plurality of remote operators simultaneously control a plurality of vehicles 46 (moving bodies).

The front end 2 forms the remote operator side of the remote control system 1. The front end 2 includes an operator terminal 20 and a controller 25. Note that the operator terminal 20 and the controller 25 may be integrally configured.

The back end 3 relays transmission and reception of information in the corresponding pair of the front end 2 and the edge 4. For example, the back end 3 receives video and vehicle information transmitted from the edge 4, and transmits the received video and the vehicle information to the corresponding front end 2. For example, the back end 3 receives various control signals including mode switching and traveling instruction transmitted from the front end 2, and transmits the received control signals to the corresponding edge 4. The back end 3 includes a server 30. Note that the back end 3 may be realized by cooperation of a plurality of servers 30. Here, the vehicle information is an example of information regarding a moving body.

The edge 4 forms a remote control target side of the remote control system 1. The edge 4 includes an edge device 40, a camera 45, and a vehicle 46. Note that at least two of the edge device 40, the camera 45, and the vehicle 46 may be integrally configured. For example, the camera 45 may include an in-vehicle camera of the vehicle 46. For example, the edge device 40 may be realized by a computer mounted on the vehicle 46.

The front end 2, the back end 3, and the edge 4 operate in cooperation via communication, but are asynchronous in a strict sense. For example, the front end 2 and the back end 3 are communicably connected to each other via an arbitrary electric communication line such as a Local Area Network (LAN). Note that communication between the front end 2 and the back end 3 may be realized via the Internet. The back end 3 and the edge 4 are communicably connected to each other via an arbitrary electric communication line such as the Internet.

Here, the remote control system 1 according to the embodiment is an information processing system (remote operation type vehicle operation system) that performs remote control in which an operator remotely views, assists, and/or maneuvers the autonomously travelable vehicle 46 (autonomous moving body). The remote control system 1 provides various services such as delivery, security, cleaning, childcare, nursing care, sales, agricultural work, manufacturing, load maneuvering, transportation, and construction by the remote control. In the remote control system 1, an operator is assigned in response to a request (remote request) for support from the vehicle 46 requiring remote control, and the assigned operator intervenes in the control of the vehicle 46 such as remote assistance and remote maneuvering. The server 30 according to the embodiment is an information processing device (remote control support device) that supports remote control of the vehicle 46. In addition, the operator terminal 20 according to the embodiment is an information processing device (terminal device) operated by an operator in a remote control room installed in a control center or the like. Furthermore, the vehicle 46 according to the embodiment is an example of a moving body capable of autonomous traveling, and is used for providing various services.

As an example, the remote control system 1 according to the embodiment can be constructed by applying edge computing. In this case, for example, the edge 4 is used as the network peripheral edge (edge) portion, but another device may be used as the edge.

As an example, the vehicle 46 is an example of a moving body that executes various tasks including autonomous traveling regarding various services provided by the remote control system 1, such as delivery, security, cleaning, childcare, nursing care, sales, agricultural work, manufacturing, load maneuvering, transportation, and construction. For example, the vehicle 46 is a moving body configured to autonomously move and execute a predetermined task. For example, the vehicle 46 is a moving body configured to be able to execute a predetermined task by moving in accordance with a remote operation of an operator monitoring the plurality of vehicles 46.

Note that the moving body is not limited to a vehicle, and various moving bodies configured to be movable according to at least a remote operation by an operator can be appropriately used. The moving body may be, for example, a four-wheeled vehicle or a two-wheeled vehicle. In addition, for example, the moving body may be an Automatic Guided Vehicle (AGV), or may be various types of robots such as a construction machine, an agricultural machine, and a drone. Furthermore, these moving bodies are not limited to those transporting a person, and may be those transporting an object other than a person, or may be those providing a specific service not limited to transportation.

As an example, the vehicle 46 transmits a support request (remote request) by remote control in accordance with the remote operation to the server 30 when the own device falls into a state in which the own device cannot autonomously travel, for example, when a falling object or an obstacle such as a vehicle parked on a road (road parking vehicle) is detected on a course. This support request may be an assistance request that requests support by remote assistance, or may be a maneuvering request that requests support by remote maneuvering. As an example, the server 30 transmits an image captured by a camera mounted on the vehicle 46 to the corresponding operator terminal 20. As an example, when receiving the support request from the vehicle 46, the server 30 transmits, to the operator terminal 20, a remote operation request for requesting an operation (remote operation) of remote assistance or remote maneuvering by the operator. As an example, the operator terminal 20 displays a display screen including an image (video) captured by, for example, a camera 45 such as a camera mounted on the vehicle 46. The display screen includes at least one image (video) related to at least one vehicle 46 which the operator who operates the operator terminal 20 is in charge of. While viewing the display screen of the operator terminal 20, the operator monitors the respective situations of the at least one vehicle 46 in charge. This monitor is an example of remote viewing with respect to the plurality of vehicles 46 by the operator based on the video data transmitted from each of the plurality of vehicles 46. As an example, when receiving a remote operation request (remote request) from the server 30, the operator terminal 20 notifies the operator who operates the own terminal that support by remote operation is requested. The operator operates the controller 25 connected to the operator terminal 20 while viewing the display screen, and performs support such as moving the vehicle 46 by remote control of remotely assisting or remotely maneuvering the vehicle 46 that has made the support request. The support of the vehicle 46 by the remote control is an example of the remote operation of the operator based on the video data transmitted from the vehicle 46 to be remotely operated with respect to the vehicle 46 to be remotely operated among the plurality of vehicles 46.

Note that the display screen of the operator terminal 20 may be a screen or an image generated by the operator terminal 20 based on the display information from the server 30, or may display an image (display information) generated in the server 30.

As described above, the remote control system 1 according to the embodiment is configured to be capable of executing the information processing method (remote control support method) for supporting remote control that is viewing, assisting, and/or maneuvering of vehicle information remotely by the operator with respect to the vehicle 46, which is performed based on the image for remote control captured by the camera 45.

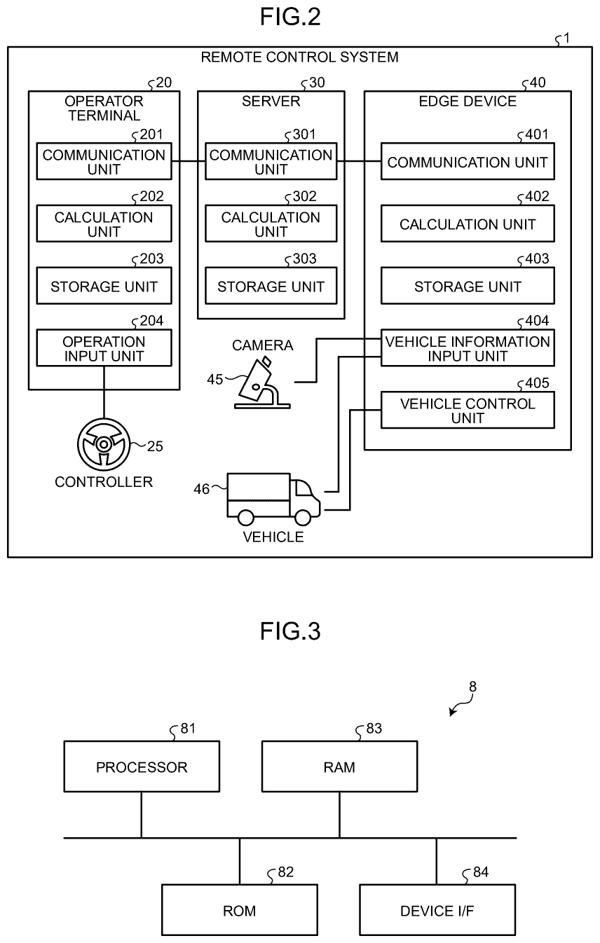

FIG. 2 is a diagram illustrating an example of a configuration of each device included in the remote control system 1 according to the embodiment. Although FIG. 2 illustrates one operator terminal 20 and one edge device 40, the configurations of other operator terminals 20 and edge devices 40 included in the remote control system 1 are similar. Hereinafter, configurations of the operator terminal 20, the server 30, and the edge device 40 will be described with reference to FIG. 2.

### Configuration Example of Operator Terminal

The operator terminal 20 includes a communication unit 201, a calculation unit 202, a storage unit 203, and an operation input unit 204.

The communication unit 201 communicates with the server 30.

As an example, the communication unit 201 may request vehicle information such as a camera video from the server 30, or may receive vehicle information transmitted from the vehicle 46 at a predetermined cycle via the server 30. Transmission information may be attached to the vehicle information at the edge 4. That is, the communication unit 201 may receive the transmission information attached to the vehicle information.

As an example, the communication unit 201 may transmit, to the server 30, a control signal corresponding to an operation input of an operator with respect to the controller 25. The control signal may be a mode switching signal corresponding to an input of a mode switching instruction of the operator. Furthermore, the control signal may be a travel instruction signal (automatic travel start signal or automatic travel stop signal) corresponding to an operation instruction (input) of remote assistance of the operator. In addition, the control signal may be a maneuvering signal corresponding to an operation instruction (input) of remote maneuvering of the operator. Furthermore, the control signal may be an emergency stop signal corresponding to an input of an emergency stop instruction (operation instruction) of the operator. The emergency stop instruction of the operator may be an operation instruction instructing execution of the MRM.

As an example, the communication unit 201 may periodically return the transmission information attached to the latest vehicle information to the edge 4. The transmission information of the latest vehicle information may be attached to the control signal corresponding to the operation instruction of the operator. That is, the communication unit 201 returns the transmission information of the latest vehicle information attached to the control signal corresponding to the operation instruction of the operator to the edge 4. Here, the transmission information is, for example, a transmission time from the edge 4, but may be an information acquisition time from various sensors including the camera 45, a transmission counter, or an identifier of information. The identifier is, for example, a random character string that can uniquely identify the transmission information.

The calculation unit 202 integrally controls the operation of the operator terminal 20.

As an example, the calculation unit 202 may monitor whether or not a plurality of software applications for remote control are activated in the operator terminal 20, and may prohibit activation of the second application.

As an example, the calculation unit 202 may control screen display by the display of the operator terminal 20. This screen display may include, for example, display of received vehicle information (moving body information). Furthermore, for example, the screen display may include an operation button for inputting an operation instruction of the operator. This operation button may include, for example, at least one remote monitoring button for inputting an operation instruction to start and end remote monitoring with respect to the vehicle 46 to be remotely monitored among the plurality of vehicles 46 by the operator. For example, the operation button may include at least one remote operation button for inputting an operation instruction of a remote operation for remotely controlling the target vehicle 46. Note that these operation buttons are examples of the operation buttons of the controller 25. Furthermore, for example, the screen display may include operator information indicating an operator who remotely monitors each vehicle 46. The operator who remotely monitors each vehicle 46 is an operator whose operation is acquired by the operator terminal 20 (monitoring front end) that has transitioned to the monitoring mode.

As an example, the calculation unit 202 may switch enable/disable of an operation button of the controller 25. Here, the enabling/disabling of the operation button of the controller 25 may be enabling/disabling of input of an operation instruction expressed by an operation on the operation button. Note that the enabling/disabling of the input of the operation instruction may be achieving a state in which the operation instruction can be input/cannot be input physically or on software or may be permitting/rejecting the input operation instruction. For example, the calculation unit 202 may enable a remote operation button related to the vehicle 46 to be remotely monitored in the monitoring mode. For example, in the viewing mode, the calculation unit 202 may disable the remote operation button enabled in the remote mode. For example, in the monitoring mode, the calculation unit 202 may prohibit operation of another operator on the remote monitoring button for inputting an operation instruction to end remote monitoring related to the vehicle 46 to be remotely monitored and the remote operation button. For example, the calculation unit 202 may disable a remote monitoring button for inputting an operation instruction to start remote monitoring related to the vehicle 46 targeted for remote monitoring by another operator terminal 20.

As an example, the calculation unit 202 may monitor whether vehicle information of the vehicle 46 that is a target moving body for which remote monitoring is to be performed can be received. For example, the calculation unit 202 may determine whether to switch the mode based on the reception situation of the vehicle information, such as permitting the switching to the monitoring mode when the vehicle information can be normally received.

As an example, the calculation unit 202 may hold information indicating whether the edge 4 is in the remote assistance state or the remote maneuvering state by, for example, the storage unit 203, and determine whether it is possible to transmit a control signal such as a travel instruction signal or a maneuvering signal based on the held information.

As an example, the calculation unit 202 may switch the remote control mode in response to an operation instruction from the operator. For example, when acquiring an operation instruction to start remote monitoring by the operator, the calculation unit 202 may transition the remote control mode from the viewing mode in which the operator is not responsible for control to the monitoring mode in which the operator is responsible for control. For example, when acquiring an operation instruction to end remote monitoring by the operator, the calculation unit 202 may transition the remote control mode from the monitoring mode to the viewing mode.

As an example, the calculation unit 202 may attach transmission information of the latest vehicle information received from the edge 4 to a control signal corresponding to an operation instruction of the operator.

As an example, the calculation unit 202 may perform integrity confirmation and delay monitoring of the vehicle information, monitoring of disconnection of the controller 25, and monitoring of whether or not the plurality of controllers 25 are connected. For example, the calculation unit 202 may perform the MRM including emergency stop in a case where the vehicle information is irregular or delayed by a prescribed value or more, or in a case where abnormality of controller connection is detected. Here, the vehicle information being irregular includes that the received vehicle information and/or the attached transmission information is not in a prescribed format or is not received. Performing the MRM is an example of limiting the travel of the target vehicle 46 (movement of the moving body), and for example, causing the vehicle 46 to execute the MRM. The MRM is a behavior of automatically transitioning the automatic driving vehicle to a safe state including an emergency stop at the site, and is an example of a preset measure for automatically transitioning the target moving body to a safe state. Note that the limitation of traveling may be to bring the vehicle into a stopped state (not to travel) by the MRM including emergency stop, may be to limit the vehicle speed, or may be to limit execution of other various functions related to traveling.

The storage unit 203 stores various types of information related to the operation of the operator terminal 20.

The operation input unit 204 receives a signal from the controller 25. For example, the operation input unit 204 may input a travel start instruction for the vehicle 46 by the operator. For example, the operation input unit 204 may input a travel stop instruction for the vehicle 46 by the operator. For example, the operation input unit 204 may input an operation instruction of remote maneuvering for the vehicle 46 to be remotely monitored by the operator. For example, the operation input unit 204 may input an operation instruction of emergency stop for the vehicle 46 to be remotely monitored by the operator. The emergency stop operation instruction of the operator may be an operation instruction instructing execution of the MRM.

### Configuration Example of Controller

The controller 25 is an input device connected to the operator terminal 20. The controller 25 accepts an operation of an operator. Specifically, the controller 25 generates an operation signal corresponding to the operation of the operator, and outputs the generated operation signal to the operator terminal 20.

As an example, the controller 25 may include a dedicated operation member such as a steering wheel, an accelerator pedal, or a brake pedal. Furthermore, the controller 25 may include a touch panel (touch panel display) provided on the display of the operator terminal 20. In addition, the controller 25 may be configured by a combination thereof.

As an example, the controller 25 may include an operation button for inputting an operation instruction of the operator. This operation button may include, for example, at least one remote monitoring button for inputting an operation instruction to start and end remote monitoring with respect to the vehicle 46 to be remotely monitored among the plurality of vehicles 46 by the operator. For example, the operation button may include at least one remote operation button for inputting an operation instruction of a remote operation for remotely controlling the target vehicle 46. For example, the controller 25 may have a remote monitoring start button for inputting an instruction to start remote monitoring in which the operator is responsible for control. For example, the controller 25 may have a remote monitoring end button for inputting an end instruction for remote monitoring. For example, the controller 25 may have a travel start instruction button for the operator to input a travel start instruction for the vehicle 46. For example, the controller 25 may have a travel stop instruction button for the operator to input a travel stop instruction for the vehicle 46. The controller 25 may have an emergency stop instruction button for the operator to input an emergency stop instruction for the vehicle 46. The emergency stop instruction of the operator may be an operation instruction instructing execution of the MRM.

### Configuration Example of Server

As illustrated in FIG. 2, the server 30 includes a communication unit 301, a calculation unit 302, and a storage unit 303.

The communication unit 301 communicates with each of the operator terminal 20 and the edge device 40. As an example, the communication unit 301 may transmit vehicle information (video etc.) of the vehicle 46 transmitted from the edge device 40 to the operator terminal 20 that performs remote control of remote viewing, remote assistance, and remote maneuvering. As an example, the communication unit 301 may transmit the control signal from the operator terminal 20 to the corresponding edge device 40.

The calculation unit 302 integrally controls the operation of the server 30. As an example, the calculation unit 302 may monitor whether or not a plurality of operator terminals 20 are transmitting control signals to one vehicle 46. As an example, the operator terminal 20 (monitoring front end) that transitions one vehicle 46 to the monitoring mode may be limited to any one of the operator terminals 20. For example, the calculation unit 302 may perform processing so as to transmit that which has started to be transmitted first to the target vehicle 46.

The storage unit 303 stores various types of information related to the operation of the server 30.

### Configuration Example of Edge Device

As illustrated in FIG. 2, the edge device 40 includes a communication unit 401, a calculation unit 402, a storage unit 403, a vehicle information input unit 404, and a vehicle control unit 405.

The communication unit 401 communicates with the server 30. As an example, the communication unit 401 may transmit the vehicle information to which the transmission information has been attached to the operator terminal 20 via the server 30 at a predetermined cycle. As an example, the communication unit 401 may receive transmission information returned from the operator terminal 20, or a control signal to which the transmission information has been attached and returned from the operator terminal 20.

The calculation unit 402 integrally controls the operation of the edge device 40.

As an example, the calculation unit 402 may attach transmission information such as acquisition time to the vehicle information from the camera 45 and/or the vehicle 46.

As an example, the calculation unit 402 may perform integrity confirmation and delay monitoring of the control signal from the server 30. For example, the calculation unit 402 may calculate the round-trip delay time including the response time of the operator by using the transmission/reception time of the transmission information. Here, the response time of the operator included in the round-trip delay time may be a time from when the vehicle information is presented to the operator to when the operation instruction of the operator based on the vehicle information is executed. That is, the round-trip delay time may be a time from when “vehicle information is acquired from the camera 45 and/or the vehicle 46” to when an operation instruction of the operator based on the vehicle information is executed “in the vehicle 46”. Alternatively, the round-trip delay time may be a time from when “vehicle information is transmitted from the edge device 40” to when an operation instruction of the operator based on the vehicle information is “instructed from the edge device 40 to the vehicle 46”. For example, the calculation unit 402 may calculate the expected round-trip delay time including the expected response time by using the transmission/reception time of the transmission information. Here, the expected response time may be a time from when the vehicle information is presented to the operator to when the operation instruction of the operator based on the vehicle information is executed. The expected response time may be, for example, determined in advance for each operator and stored in the storage unit 403.

As an example, in a case where the calculated round-trip delay time is within a predetermined time, the calculation unit 402 may execute control of the vehicle 46 by the vehicle control unit 405 according to a control signal from the operator terminal 20 in the corresponding monitoring mode. The predetermined time related to the round-trip delay time may be, for example, determined in advance and stored in the storage unit 403. The predetermined time may be different according to any of the type of the support request, the operator or experience of the operator, the type of the vehicle 46, the state of the vehicle 46, the vehicle speed, the place, and the surrounding environment. The state of the vehicle 46 may be an occurrence situation or presence or absence of a failure or an error, an automatic driving level (Lv2, 3, 4), or the like. Furthermore, the surrounding environment may be the type, number, positional relationship, speed relationship, and the like of objects around the vehicle 46.

As an example, in a case where the reception information from the server 30 is irregular or delayed by a prescribed value or more, the calculation unit 402 may perform the MRM including emergency stop of the vehicle 46. For example, when the calculated round-trip delay time exceeds a predetermined time, the calculation unit 402 may not allow the control of the vehicle 46 according to the control signal from the operator terminal 20 in the corresponding monitoring mode. Furthermore, in this case, the calculation unit 402 may execute the MRM including the emergency stop of the vehicle 46 for the target vehicle 46. For example, when the calculated expected round-trip delay time exceeds a predetermined time, the calculation unit 402 may execute the MRM including emergency stop of the vehicle 46 for the target vehicle 46. The predetermined time related to the expected round-trip delay time may be, for example, determined in advance and stored in the storage unit 403. The predetermined time may be different depending on the type of the support request, the operator, or the experience of the operator. For example, the calculation unit 402 may not execute the MRM including emergency stop of the vehicle 46 for the target vehicle 46 based on the expected round-trip delay time for another operator terminal 20 by the operator terminal 20 in the corresponding monitoring mode. Not executing the MRM including emergency stop based on the expected round-trip delay time may mean ignoring information from another front end 2 in the calculation, not calculating the expected round-trip delay time, or not executing the MRM including emergency stop after the calculation. Note that in the present disclosure, the MRM mainly exemplifies the emergency stop, but the MRM may be an evacuation action to another safe state other than the emergency stop.

As an example, the calculation unit 402 may monitor whether or not a plurality of operator terminals 20 are transmitting control signals to one vehicle 46. As an example, the operator terminal 20 (monitoring front end) that transitions one vehicle 46 to the monitoring mode may be limited to any one of the operator terminals 20. For example, the calculation unit 402 may process the operator terminal 20 that has started receiving first as the operator terminal 20 that remotely monitors the target vehicle 46. For example, the calculation unit 402 may reject a control signal from another operator terminal 20 of the operator terminal 20 that performs remote monitoring.

As an example, the calculation unit 402 may cancel the monitoring mode in a case where the driver directly operates the vehicle 46 being remotely monitored and/or the driver directly operates the automatic driving system of the vehicle 46.

As an example, the calculation unit 402 may switch whether to transmit a control signal to the vehicle 46 according to the remote control mode.

As an example, the calculation unit 402 may compare the content (instruction content) instructed and controlled to the vehicle 46 by the vehicle control unit 405 with the information (execution content) from the vehicle 46. As an example, the calculation unit 402 may determine that there is an abnormality when the comparison results do not match, and perform the MRM including emergency stop of the vehicle 46.

The storage unit 403 stores various types of information related to the operation of the edge device 40.

The vehicle information input unit 404 receives various types of vehicle information of the vehicle 46 such as camera videos and vehicle body information from the camera 45 and/or the vehicle 46. The vehicle body information may include sensor information from a Global Navigation Satellite System (GNSS) system such as Light Detection and Ranging (LiDAR), radar, sonar, and Global Positioning System (GPS) attached to the vehicle body of the vehicle 46, and sensing information such as target information, position information, and map information obtained by processing the sensor information.

The vehicle control unit 405 controls the operation of the vehicle 46 by transmitting a control signal to the vehicle 46.

### Configuration Example of Camera

The camera 45 is an input device connected to the edge device 40. The camera 45 acquires an image for remote control, and outputs the acquired image to the edge device 40. Note that this image may be a still image or a moving image (video). In addition, this image may be common to or different from an image provided for autonomous traveling of the vehicle 46.

### Configuration Example of Vehicle

The vehicle 46 is a moving body connected to the edge device 40. As described above, the vehicle 46 is a moving body that executes various tasks including autonomous traveling regarding various services provided by the remote control system 1. As an example, the vehicle 46 is a remote operation type small vehicle.

FIG. 3 is a diagram illustrating an example of a hardware configuration of an information processing device 8 that implements each function of each device included in the remote control system 1 according to the embodiment. The information processing device 8 is a computer that integrally controls the operation of the entire device in each device included in the remote control system 1.

Note that the information processing device 8 that implements each function of the vehicle 46 may be an Electronic Control Unit (ECU) provided inside the vehicle 46, a Domain Control Unit (DCU) such as a Cockpit Domain Controller (CDC) in which a plurality of ECUs are integrated, or a computer such as an On Board Unit (OBU).

As illustrated in FIG. 3, the information processing device 8 includes a processor 81, a Read Only Memory (ROM) 82, a Random Access Memory (RAM) 83, and a Device interface (I/F) unit 84.

The processor 81 is, for example, a Central Processing Unit (CPU), and in addition to or instead of the CPU, at least one of various processors such as a Graphics Processing Unit (GPU), an Application Specific Integrated Circuit (ASIC), and a Field Programmable Gate Array (FPGA) can be used as appropriate. Here, the processor 81 according to the embodiment is an example of at least one processor in the information processing device 8.

As an example, the processor 81 of the operator terminal 20 implements functions as the communication unit 201, the calculation unit 202, the storage unit 203, and the operation input unit 204 illustrated in FIG. 2, by for example, executing a program stored in the ROM 82. As an example, the processor 81 of the server 30 implements functions as the communication unit 301, the calculation unit 302, and the storage unit 303 illustrated in FIG. 2 by, for example, executing a program stored in the ROM 82. As an example, the processor 81 of the edge device 40 implements functions as the communication unit 401, the calculation unit 402, the storage unit 403, the vehicle information input unit 404, and the vehicle control unit 405 illustrated in FIG. 2 by, for example, executing a program stored in the ROM 82.

Note that, in the example of FIG. 2, only the functions necessary for describing the main part of the embodiment are illustrated, but the functions of each of the devices included in the remote control system 1 are not limited thereto. In the embodiment, the processor 81 implements each function of each device including the function of each unit described above by executing the program stored in the ROM 42. However, this is not the sole case, and some or all of these functions may be realized by a dedicated hardware circuit. Furthermore, in each device of the remote control system 1, two or more functions may be integrated and implemented as one function. Similarly, in each device of the remote control system 1, one function may be divided and implemented as two or more functions. In addition, in the remote control system 1, the functions of two or more devices may be integrated and implemented as at least one function of any device. Similarly, in the remote control system 1, the function of one device may be divided and implemented as two or more functions of two or more devices.

The ROM 82 is a non-volatile memory, and is an auxiliary storage device that stores various types of information including programs to be executed by the processor 81. The memory of the information processing device 8 is not limited to the ROM 82, and various recording media and recording devices such as a Hard Disk Drive (HDD), a Solid State Drive (SSD), and a Flash memory can be used as appropriate. The RAM 83 is a volatile memory having a work area of the processor 81 and is a main storage device. Here, the ROM 82 and the RAM 83 according to the embodiment are examples of at least one memory in the information processing device 8. The device I/F unit 84 is an interface for connecting with other devices of the information processing device 8 in each device included in the remote control system 1, such as a communication device (not illustrated), a display device (not illustrated), and an input device (not illustrated).

As an example, the device I/F unit 84 of the operator terminal 20 connects the controller 25. As an example, the device I/F unit 84 of the edge device 40 connects the camera 45 and the vehicle 46.

Next, an operation example of each embodiment of the remote control system 1 configured as described above will be described with reference to the drawings. Note that the operation procedure and the flow of processing described below are examples, and it is possible to arbitrarily change the order of steps, delete some steps, and add other steps.

### Regarding Assumed Use Case

Here, a use case of the remote control system 1 assumed by the embodiment of the present disclosure will be described.

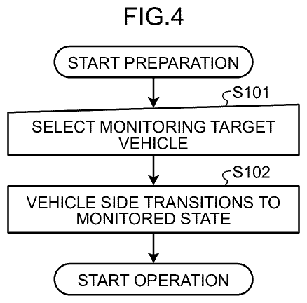

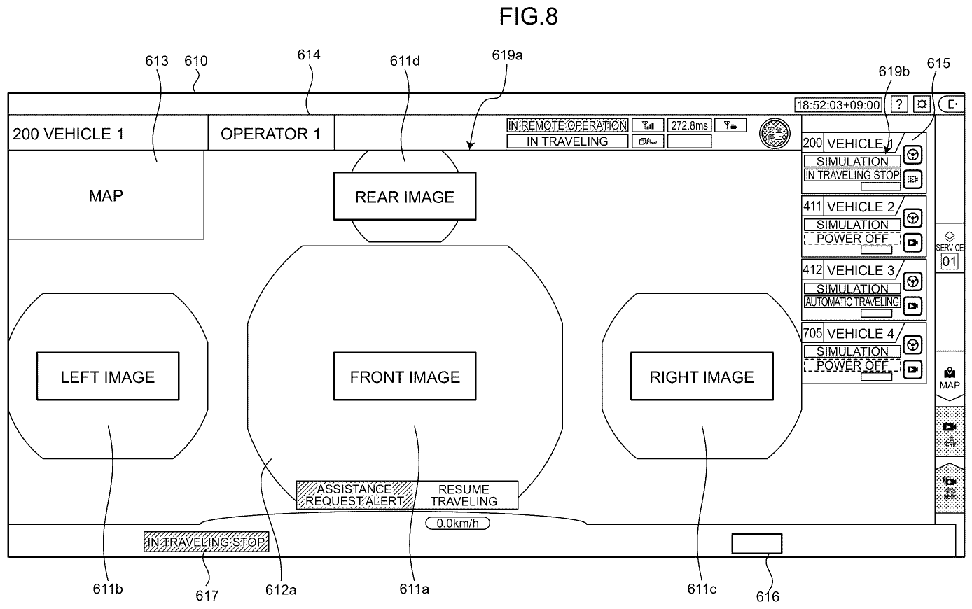

FIG. 4 is a flowchart illustrating an example of a flow of starting an operation of remote monitoring in the remote control according to the embodiment. The flow of FIG. 4 is started when the remote control mode is in the viewing mode. First, the operator selects a target vehicle 46 for which remote monitoring is to be started, and presses a monitoring start/end button 616 (see FIG. 8) (S101). When the monitoring start/end button 616 is pressed by the operator in the viewing mode, the operator terminal 20 acquires the monitoring start operation instruction. In response to the monitoring start operation instruction, the operator terminal 20 transitions the remote control mode to the monitoring mode (S102). As a result, the remote control system 1 shifts to the monitoring mode. That is, the vehicle 46 transitions to the monitored state.

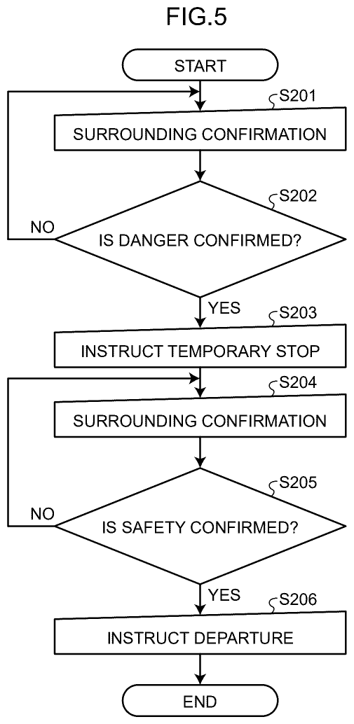

FIG. 5 is a flowchart illustrating an example of a flow of operation of remote monitoring in the remote control according to the embodiment. The flow of FIG. 5 is started when the remote control mode is in the monitoring mode. First, the operator performs surrounding confirmation of the vehicle 46 to be remotely monitored based on the vehicle information included in the screen display of the operator terminal 20 (S201), and continues the surrounding confirmation when not confirming danger (S202: No). For example, in the surrounding confirmation, the operator checks camera videos (see image 611 and FIG. 8) of the front, rear, left, and right of the vehicle 46, sensor information, notification, and the like. When the operator confirms a dangerous event in the surrounding confirmation (S202: Yes), the operator inputs an operation instruction for instructing traveling stop to the operator terminal 20 by pressing a vehicle operation instruction button 612a (see FIG. 8) (S203). As a result, the vehicle 46 being remotely monitored is temporarily stopped. As described above, in the remote monitoring, the operator performs safety confirmation of the traveling vehicle 46, and gives a stop instruction when a dangerous event occurs. Thereafter, the operator performs surrounding confirmation of the vehicle 46 to be remotely monitored based on the vehicle information included in the screen display of the operator terminal 20 (S204), and continues the surrounding confirmation when safety cannot be confirmed (S205: No). Then, when safety is confirmed in the surrounding confirmation (S205: Yes), the operator inputs an operation instruction for instructing to traveling start to the operator terminal 20 by pressing the vehicle operation instruction button 612a (see FIG. 8) again (S206). As a result, the vehicle 46 being remotely monitored resumes traveling.

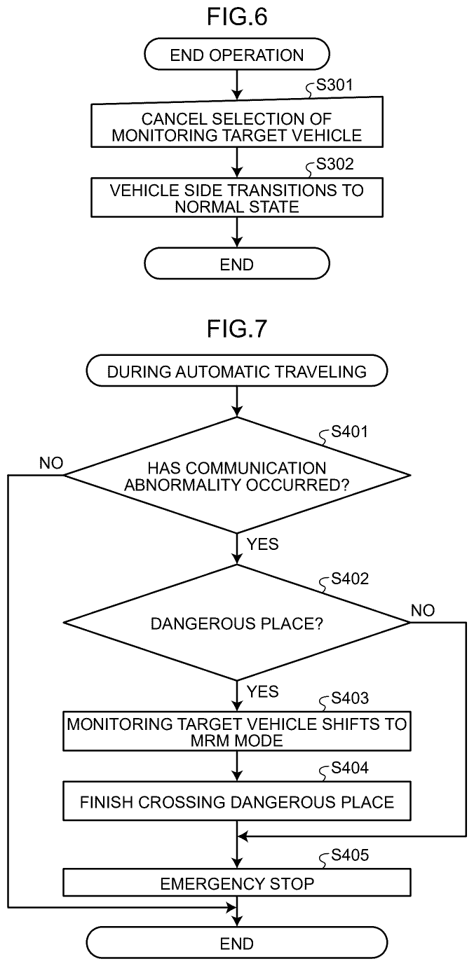

FIG. 6 is a flowchart illustrating an example of a flow of ending an operation of remote monitoring in the remote control according to the embodiment. The flow of FIG. 6 is started when the remote control mode is in the monitoring mode. First, the operator selects a target vehicle 46 for which remote monitoring is to be ended, and presses the monitoring start/end button 616 (see FIG. 8) (S301). When the monitoring start/end button 616 is pressed by the operator in the monitoring mode, the operator terminal 20 acquires the monitoring end operation instruction. The operator terminal 20 transitions the remote control mode to the viewing mode in response to the operation instruction to end the monitoring (S302). As a result, the remote control system 1 shifts to the viewing mode. That is, the vehicle 46 transitions to the normal state (autonomous traveling state). Note that, for the vehicle 46 that cannot autonomously travel in the viewing mode, the transition to the normal state does not mean the transition to the autonomous traveling state. The normal state may be, for example, a state immediately before the monitoring mode is started, a state before a request for support (remote request) is made, or the like.

FIG. 7 is a flowchart illustrating an example of a flow of processing during automatic traveling in the remote control according to the embodiment. FIG. 7 illustrates a flow in a case where the MRM execution instruction is made in the determination of the remote control system 1 when the operator cannot perform the monitoring work. The edge device 40 determines whether a communication abnormality has occurred (S401). When no communication abnormality has occurred (S401: No), the flow of FIG. 7 ends. When the communication abnormality has occurred (S401: Yes), the edge device 40 determines whether the vehicle 46 is in a dangerous place (S402). Here, the dangerous place includes, for example, a place where the vehicle 46 should not stop, such as a pedestrian crossing. When the vehicle 46 is in a dangerous place (S402: Yes), the edge device 40 causes the vehicle 46 to be monitored to execute the MRM (S403), and after the vehicle 46 finishes crossing the dangerous place (S404), executes the MRM including emergency stop (S405). On the other hand, when the vehicle 46 is not in a dangerous place (S402: No), the edge device 40 executes the MRM including emergency stop (S405). Thereafter, the flow of FIG. 7 ends. Note that the flow of FIG. 7 may be executed by the server 30.

### Regarding Screen Display

Here, screen display of remote control according to a use case assumed by the embodiment of the present disclosure will be described.

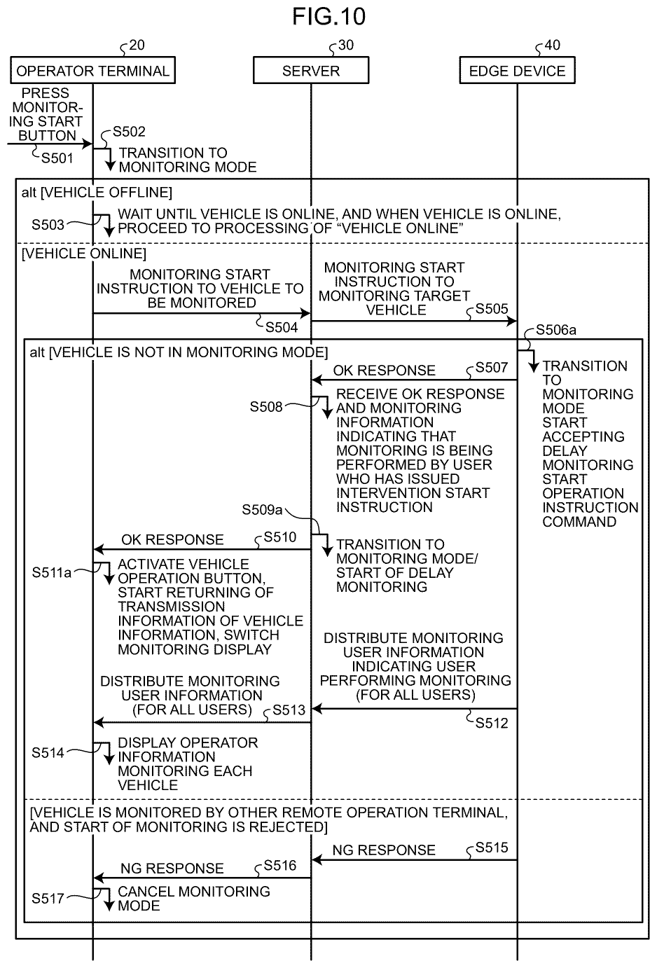

FIG. 8 is a diagram illustrating an example of a screen display of the operator terminal in the remote control according to the embodiment. A display screen 610 of FIG. 8 is an example of a screen display presented to the operator of the operator terminal 20 performing remote control. The display screen 610 of FIG. 8 includes at least one image 611 for remote control and a map 613 around the vehicle 46 to be remotely controlled. Note that in the example of FIG. 10, a front image 611a, a left image 611b, a right image 611c, and a rear image 611d are exemplified, but this is not the sole case. The image 611 on the display screen 610 may be any one of these images or may further include other images. In addition, the display screen 610 of FIG. 8 includes an operator information display 614 that displays information of a monitoring person (operator) of remote monitoring, and a vehicle state display 617. The operator information display 614 displays information indicating an operator such as an ID and a name of the operator who remotely monitors the vehicle 46 displaying the vehicle information such as the image 611. In the example of FIG. 8, the operator information display 614 is a display such as “operator 1” indicating an operator performing remote monitoring of “vehicle 1”. The vehicle state display 617 displays a vehicle state of the vehicle 46 such as traveling stop or automatic traveling.

Note that the operator information display 614 may be a display mode corresponding to the monitoring state of the vehicle 46. As an example, the operator information display 614 may be blank in a case where the vehicle 46 displaying the vehicle information is not in the monitored state, that is, when no operator is performing remote monitoring. As an example, the operator information display 614 may display information indicating an operator, such as a name and an ID of the operator performing remote monitoring on the vehicle 46 displaying the vehicle information. As an example, a display 416 may display a case where an operator of the own terminal is performing monitoring and a case where an operator of another terminal is performing monitoring in an identifiable manner. For example, in a case where the vehicle 46 displaying the vehicle information is remotely monitored by the operator of the own terminal, the display 416 may highlight-display information indicating the operator. The highlight-display may be realized by changing the color of the character color of the display or the background color, or may be realized by displaying a frame, an icon, or the like. In addition, the display 416 is not limited to one highlight-display, and may be one in which the color, frame, icon, or the like of the display is made different between oneself and others to determine which of oneself or other is performing monitoring. In this manner, the display 416 may be a display of a monitoring operator name that facilitates identification of oneself and others.

Furthermore, the display screen 610 of FIG. 8 includes a vehicle list display 615. The vehicle list display 615 displays information on each vehicle 46 to be remotely controlled by the remote control system 1. In the example of FIG. 8, the vehicle list display 615 includes information for uniquely identifying each vehicle 46, such as a vehicle ID and a vehicle name, and information indicating the state of each vehicle 46, such as during travel stop or automatic traveling, and power OFF. Note that the arrangement order of the vehicles 46 in the vehicle list display 615 may be changed according to the presence or absence of the occurrence of the assistance request, the presence or absence of monitoring, the vehicle state, and the like. Note that as illustrated in FIG. 8, the vehicle list display 615 may include an operation button (an icon of a steering wheel in FIG. 8) for inputting an operation instruction for remote monitoring and an operation button (an icon of a camera in FIG. 8) for inputting an operation instruction for remote viewing. Furthermore, the display screen 610 of FIG. 8 includes a vehicle operation instruction button 612a and a monitoring start/end button 616. The vehicle operation instruction button 612a is an operation button for inputting an operation instruction for remote assistance (travel start instruction/travel stop instruction) for the vehicle 46 displaying the vehicle information. In the example of FIG. 8, the vehicle operation instruction button 612a is realized by the front image 611a. The monitoring start/end button 616 is an operation button for inputting an operation instruction to start and/or end remote monitoring for the vehicle 46 displaying the vehicle information.

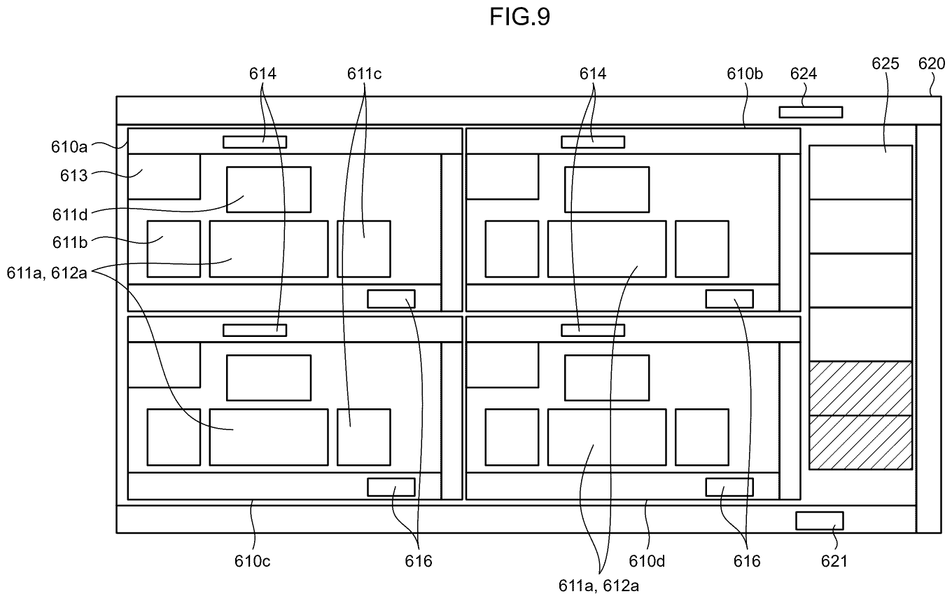

FIG. 9 is a diagram illustrating another example of the screen display of the operator terminal in the remote control according to the embodiment. A display screen 620 of FIG. 9 is an example of a screen display presented to the operator of the operator terminal 20 performing remote control. The display screen 620 of FIG. 9 includes a plurality of screens 610a to 610d corresponding to the plurality of vehicles 46. Each of the plurality of screens 610a to 610d is similar to, for example, the display screen 610 in FIG. 8. The display screen 620 of FIG. 9 includes a simultaneous monitoring start/end button 621 for the vehicle 46 on the screen and an operator information display 624 of the own terminal. The simultaneous monitoring start/end button 621 is an operation button corresponding to the simultaneous operation of all the monitoring start/end buttons 616 of the plurality of screens 610a to 610d. Note that, in the example of FIG. 9, a case where an integrated vehicle list display 625 is displayed instead of the vehicle list display 615 of each screen will be exemplified.

FIG. 10 is a sequence diagram illustrating an example of a flow of information processing at the start of remote monitoring executed by each unit of the remote control system 1 according to the embodiment. In a case where the monitoring start operation instruction is acquired (S501), the operator terminal 20 transitions to the monitoring mode (S502). In a case where the vehicle 46 to be remotely monitored is offline, the operator terminal 20 stands by until it becomes online, and when it becomes online, proceeds to the processing of S504 and subsequent steps (S503).

In a case where the vehicle 46 to be monitored is online, the operator terminal 20 transmits, to the server 30, a monitoring start instruction for the vehicle 46 (S504). Furthermore, the server 30 that has received this transmits the monitoring start instruction from the operator terminal 20 to the edge device 40 that controls the corresponding vehicle 46 (S505).

When the corresponding vehicle 46 is not in the monitoring mode, the edge device 40 that has received the monitoring start instruction transitions to the monitoring mode, starts delay monitoring, and starts accepting an operation instruction command (control signal) (S506a). In addition, the edge device 40 transmits an OK response notifying that the standby state of the control signal has been entered to the server 30 (S507). Furthermore, the server 30 that has received this receives, from the edge device 40, monitoring information indicating that monitoring is being performed by the user who has issued the intervention start instruction by the monitoring start instruction (S508), and then transitions to the monitoring mode and starts delay monitoring (S509a). Thereafter, the server 30 transmits an OK response notifying that the standby state of the control signal has been entered to the operator terminal 20 (S510). In addition, the operator terminal 20 that has received this enables the vehicle operation instruction button 612a, starts returning the transmission information of the vehicle information, and switches the screen display to the display during monitoring (S511a). In addition, the edge device 40 after transmitting the OK response to the server 30 and/or the server 30 distributes monitoring user information indicating which user is monitoring to all users (S512 to S513). Furthermore, the operator terminal 20 that has received the monitoring user information displays the operator information monitoring each vehicle 46 (S514) (see FIGS. 8 to 9).

When the corresponding vehicle 46 is remotely monitored by another operator terminal 20, the remote start instruction from the operator terminal 20 is rejected by the edge device 40. In this case, the edge device 40 transmits the NG response to the operator terminal 20 via the server 30 (S515 to S516). Upon receiving the NG response, the operator terminal 20 cancels the monitoring mode (S517).

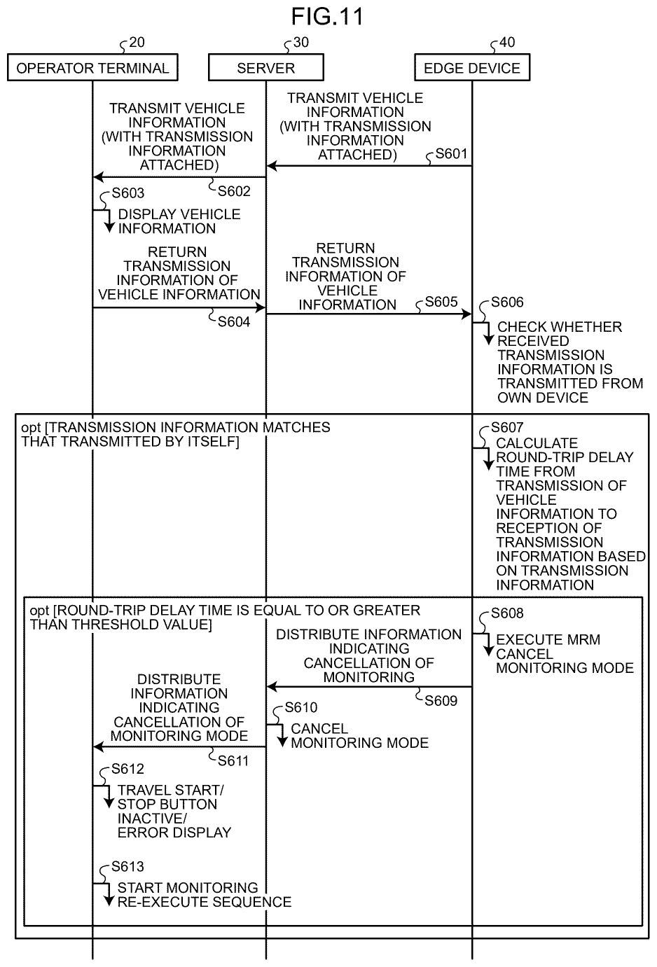

FIG. 11 is a sequence diagram illustrating an example of a flow of information processing related to communication delay monitoring at the time of performing remote monitoring, executed by each unit of the remote control system 1 according to the embodiment. In the monitoring mode, the edge device 40 transmits the vehicle information to which the transmission information is attached to the operator terminal 20 via the server 30 (S601 to S602). Furthermore, the operator terminal 20 that has received this displays the vehicle information (S603), and returns the transmission information attached to the received vehicle information to the edge device 40 via the server 30 (S604 to S605). Furthermore, the edge device 40 that has received this checks whether the transmission information returned from the operator terminal 20 via the server 30 is transmitted from the own device (S606). When the transmission information matches the one transmitted from the own device, the edge device 40 calculates an expected round-trip delay time from the transmission of the vehicle information to the reception thereof based on the transmission information (S607a). Then, in a case where the expected round-trip delay time is equal to or more than the predetermined threshold value, the edge device 40 executes the MRM such as emergency stop, cancels the monitoring mode (S608), and then distributes information indicating the monitoring cancellation to the server 30 (S609). Furthermore, after canceling the monitoring mode (S610), the server 30 that has received this distributes the information indicating the monitoring cancellation to the operator terminal 20 (S611). Furthermore, the operator terminal 20 that has received this disables the vehicle operation instruction button 612a for instructing to start/stop traveling and displays an error (S612). Thereafter, the operator terminal 20 re-executes the monitoring start sequence (S613).

Note that the threshold value of the expected round-trip delay time may be set longer only for the first time. This threshold value for the first time may be set in consideration of a delay related to internal state switching processing.

Note that when the edge device 40 has not received the transmission information of the vehicle information, that is, the returned transmission information for a certain period of time, the edge device may execute the MRM and cancel the monitoring mode.

Note that the edge device 40 may periodically compare the transmission time of the transmission information of the last received vehicle information with the current time. Then, in a case where the comparison result (time difference) is equal to or greater than a predetermined threshold value, the edge device 40 may execute the MRM and cancel the monitoring mode. According to this delay monitoring, both a case where a delay has occurred and a case where transmission information is not returned can be detected by one processing.

Note that the execution of the MRM and the cancellation of the monitoring mode may be performed in a case where the time information in the edge device 40 is rewound for equal to or longer than a certain period of time. As a result, it is possible to cope with a case where the internal time of the edge device 40 becomes abnormal. Note that whether the time information in the edge device 40 has been rewound for a certain period of time or more may be, for example, determined based on the time information before and after correction in a case where the time correction is performed in the edge device 40 based on communication with the outside or the like, may be determined by comparison with the time information in each terminal in the server 30 or the operator terminal 20 that has received the transmission information from the edge device 40, or may be determined by comparison with the transmission information transmitted in the edge device 40.

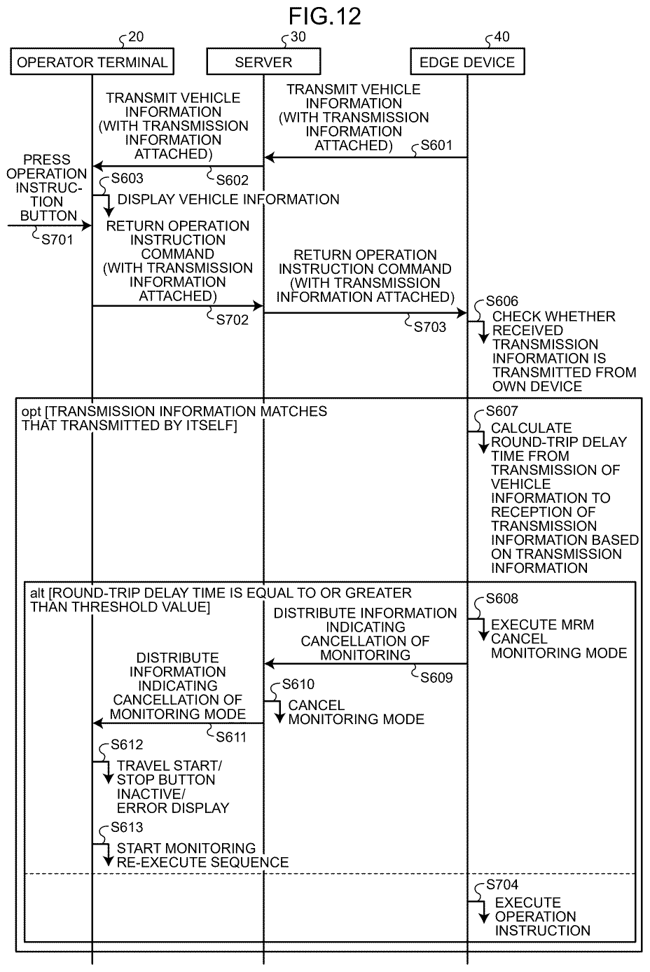

FIG. 12 is a sequence diagram illustrating an example of a flow of information processing related to an operation instruction by an operator at the time of performing remote monitoring, executed by each unit of the remote control system 1 according to the embodiment. Here, differences from the flow of FIG. 11 will be mainly described. In the monitoring mode, the operator terminal 20 receives the vehicle information to which the transmission information is attached from the edge device 40 via the server 30 (S601 to S602), and displays the received vehicle information (S603). Furthermore, when acquiring the operation instruction by the operator (S701), the operator terminal 20 attaches the latest transmission information to the operation instruction command (control signal) and returns it to the edge device 40 via the server 30 (S702 to S703). In addition, the edge device 40 that has received this checks whether the transmission information returned from the operator terminal 20 via the server 30 is transmitted from the own device (S606), and calculates an actual round-trip delay time when the transmission information matches the transmission information transmitted from the own device (S607b). When the round-trip delay time does not exceed the predetermined threshold value, the edge device 40 controls the vehicle 46 according to a control signal corresponding to an operation instruction by the operator (S704). Note that the processing in the case where the round-trip delay time is equal to or more than the predetermined threshold value (S608 to S613) is similar to the flow of FIG. 11, and thus description thereof will be omitted here.

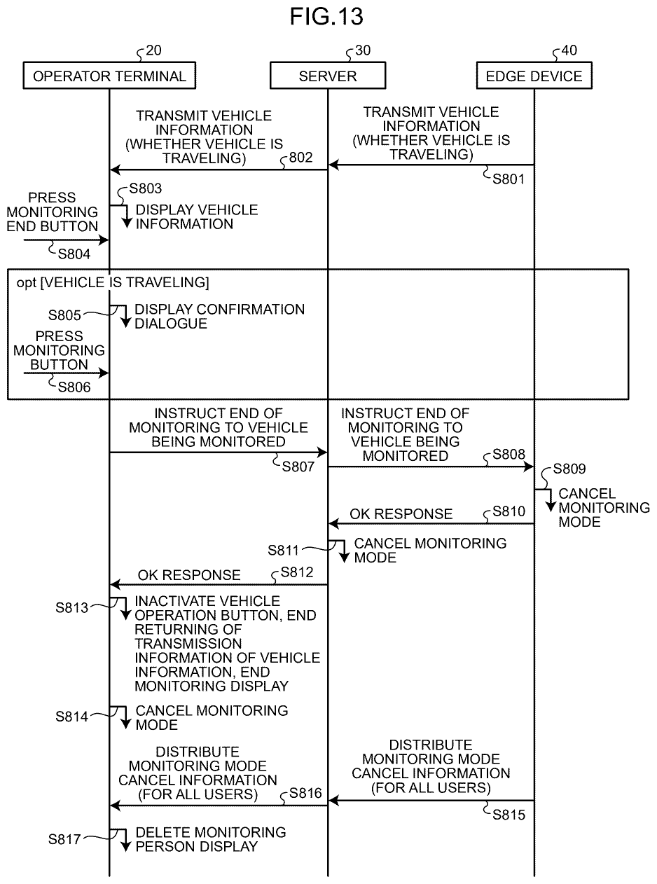

FIG. 13 is a sequence diagram illustrating an example of a flow of information processing at the end of remote monitoring executed by each unit of the remote control system 1 according to the embodiment. In the monitoring mode, the operator terminal 20 receives vehicle information including information indicating whether the vehicle is traveling from the edge device 40 via the server 30 (S801 to S802), and displays the received vehicle information (S803). Furthermore, when acquiring an operation instruction to end monitoring by the operator (S804), the operator terminal 20, in a case where the vehicle 46 being remotely monitored is traveling, displays a confirmation dialog (notification) for confirming whether or not to end remote monitoring (S805). Then, when acquiring an operation instruction to end monitoring by the operator after the confirmation dialog is displayed (S806), the operator terminal 20 transmits the monitoring end instruction to the edge device 40 via the server 30 (S807 to S808). In addition, the edge device 40 that has received this cancels the monitoring mode (S809), and then transmits an OK response notifying that the monitoring mode has been canceled according to the instruction to the server 30 (S810). In addition, the server 30 that has received this cancels the monitoring mode (S811) and transmits an OK response to the operator terminal 20 (S812). In addition, the operator terminal 20 that has received this disables the vehicle operation instruction button 612a, ends the return of the transmission information of the vehicle information, and ends the display during monitoring (S813). Thereafter, the operator terminal 20 cancels the monitoring mode (S814). In addition, furthermore, the edge device 40 after transmitting the OK response to the server 30 distributes monitoring mode cancel information indicating that the monitoring mode has been cancelled to all users (S815 to S816). Furthermore, the operator terminal 20 that has received the monitoring mode cancel information updates the operator information monitoring each vehicle 46 (S817) (see FIGS. 8 to 9).

Note that, regarding the display of the confirmation dialog (notification) (S805), the state in which the vehicle 46 being remotely monitored is traveling may be a state in which the vehicle speed (speed) of the vehicle 46 is not zero or a state in which the automatic traveling system is holding the operation right of the vehicle 46. That is, whether the vehicle 46 being remotely monitored is traveling may be determined by acquiring the vehicle speed as the vehicle information, or may be determined by acquiring the automatic driving state as the vehicle information.

Here, the operation right may be an authority to directly operate a steering wheel, an accelerator, a brake, or the like of the vehicle 46. This operation right can be held by any of the automatic driving system of the vehicle 46, the remote operator, and the driver on the vehicle 46. For example, during the remote maneuvering, the operator has the operation right. For example, during the remote assistance, the automatic driving system has the operation right. Note that the operator during the remote assistance can operate the automatic driving system.

As an example, the display (S805) of the confirmation dialog (notification) may be a display such as “Do you really wish to cancel? (OK) (Cancel)”. In a case where (OK) is selected in the confirmation dialog, the operator terminal 20 may acquire the information as an operation instruction to end monitoring by the operator after the confirmation dialog is displayed. On the other hand, in a case where (Cancel) is selected in the confirmation dialog, the processing after S807 in FIG. 13 may not be executed.

As an example, the display (S805) of the confirmation dialog (notification) may be a display such as “Do you really wish to cancel? (OK)”. In a case where (OK) is selected in the confirmation dialog, the operator terminal 20 may acquire the information as an operation instruction to end monitoring by the operator after the confirmation dialog is displayed. On the other hand, in a case where (OK) is not selected for a predetermined time defined in advance in the confirmation dialog, the display of the confirmation dialog is ended, and the processing after S807 in FIG. 13 may not be executed.

Note that the display (S805) of the confirmation dialog (notification) is not an essential configuration, and can be appropriately omitted. In this case, when the vehicle 46 being remotely monitored is traveling, the operator terminal 20 may acquire the instruction as an operation instruction to end monitoring by the operator only when the corresponding operation button is pressed for a long time. That is, in the example of FIG. 8, in the viewing mode, the operator terminal 20 may acquire the tap operation on the vehicle operation instruction button 612a as the start instruction of the remote monitoring, and in a case where the vehicle 46 is traveling during the remote monitoring, the tap operation on the vehicle operation instruction button 612a may be disabled and only the long pressing operation may be enabled. Note that the configuration is not limited to the long pressing operation, and the swipe operation may be enabled. Furthermore, the operation of disabling and/or enabling may differ between a case where the vehicle 46 is traveling and a case where the vehicle is stopped during the remote monitoring. That is, when the vehicle 46 is traveling during remote monitoring, the monitoring mode may be canceled only by an operation different from that at the time of stopping.

Note that the display of the confirmation dialog (notification) is not limited to the case where the end instruction of the remote monitoring is acquired, and it may be similarly displayed when the start instruction of the remote monitoring is acquired. In addition, the start instruction of the remote monitoring is not limited to the tap operation, and may be acquired by long pressing operation on the vehicle operation instruction button 612a or swipe operation.

Note that in a case where the vehicle 46 being remotely monitored is traveling in the monitoring mode, the operator terminal 20 may disable the monitoring start/end button 616.

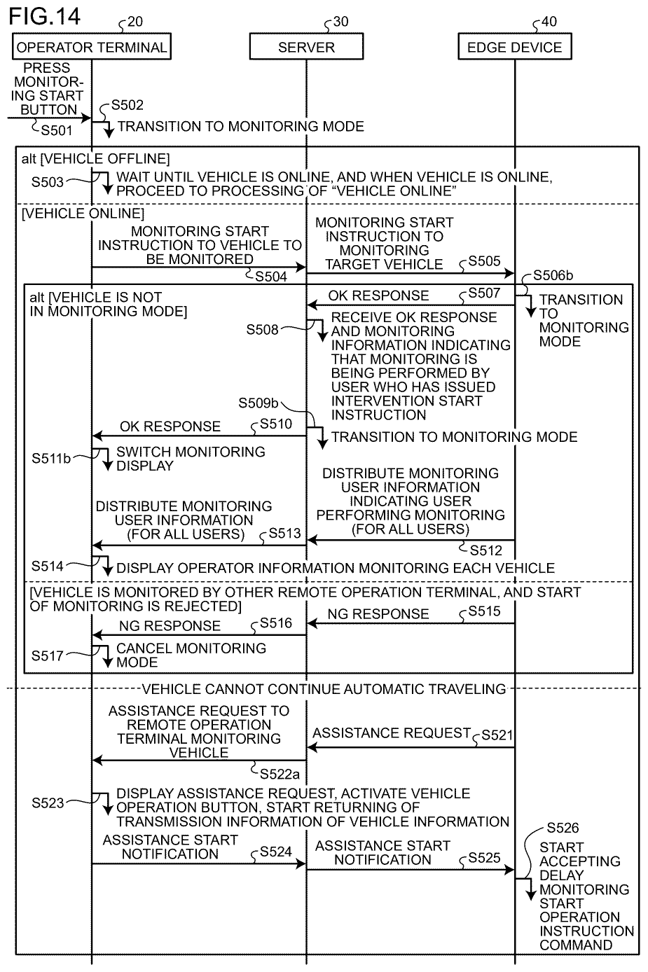

Note that, in the above-described embodiment, the case where the operator makes the transition to the monitoring mode by issuing the remote start instruction using the monitoring start/end button 616 in the viewing mode (see FIG. 10) has been exemplified, but the present invention is not limited thereto. The monitoring mode may be started only when a monitoring request is made from the side of the vehicle 46. FIG. 14 is a sequence diagram illustrating another example of a flow of information processing at the start of remote monitoring executed by each unit of the remote control system 1 according to the embodiment. Here, differences from the flow of FIG. 10 will be mainly described. When the corresponding vehicle 46 is not in the monitoring mode, the edge device 40 that has received the monitoring start instruction (S505) transitions to the monitoring mode (S506b). Thereafter, the edge device 40 transmits an OK response to the server 30 (S507). Furthermore, the server 30 that has received this receives, from the edge device 40, monitoring information indicating that monitoring is being performed by the user who has issued the intervention start instruction by the monitoring start instruction (S508), and then transitions to the monitoring mode (S509b). Thereafter, the server 30 transmits an OK response to the operator terminal 20 (S510). In addition, the operator terminal 20 that has received this, switches the screen display to the display during monitoring (S511b). Then, when the vehicle 46 cannot continue the automatic traveling, the edge device 40 transmits an assistance request to the server 30 (S521). Furthermore, the server 30 that has received this transmits the assistance request to the operator terminal 20 that has transmitted the remote monitoring instruction for the target vehicle 46 (S522a). In addition, the operator terminal 20 that has received this displays the received assistance request, enables the vehicle operation instruction button 612a similarly to the processing of S511a of FIG. 10, and starts returning the transmission information of the vehicle information (S523). Thereafter, the assistance start notification is transmitted from the operator terminal 20 to the edge device 40 via the server 30 (S524 to S525), the server 30 and the edge device 40 are transitioned to the monitoring mode similarly to the processing of S506a and S509a of FIG. 10, and the edge device 40 starts delay monitoring and accepting of the control signal similarly to the processing of S506a of FIG. 10 (S526). Note that the delay monitoring is not limited to this step, and for example, may be started at a time point before this step, such as S506b.

Note that when the vehicle 46 can automatically travel and recover, the assistance request or the transition to the monitoring mode may be canceled on the vehicle 46 side or the server 30 side.

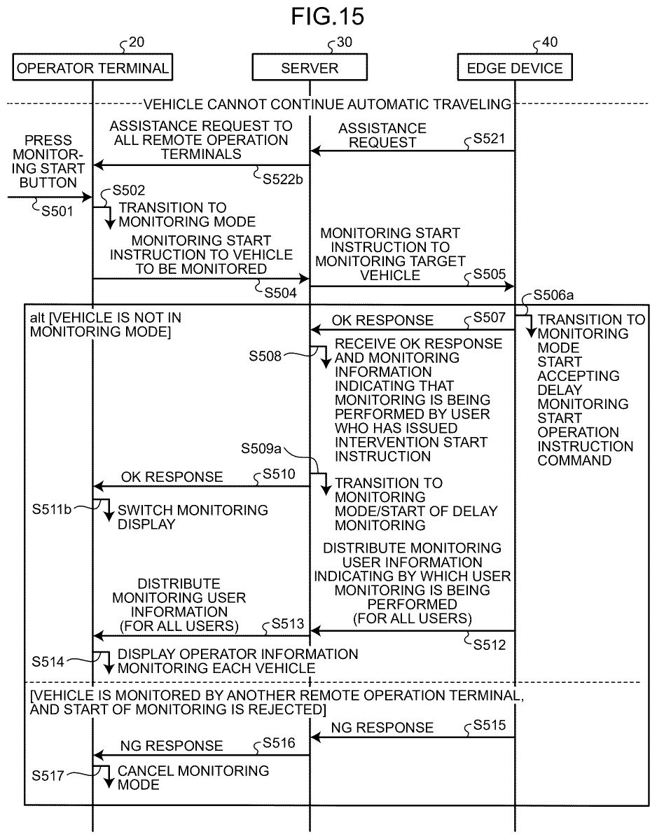

Note that, in a configuration in which the monitoring mode is started only when a monitoring request is made from the vehicle 46 side (see FIG. 14), the operator may issue a remote start instruction using the monitoring start/end button 616 after a monitoring request is made from the vehicle 46 side. FIG. 15 is a sequence diagram illustrating another example of a flow of information processing at the start of remote monitoring executed by each unit of the remote control system 1 according to the embodiment. Here, differences from the flow of FIG. 10 or FIG. 14 will be mainly described. When the vehicle 46 cannot continue the automatic traveling, the edge device 40 transmits an assistance request to the server 30 (S521). Furthermore, the server 30 that has received this transmits the assistance request to all the operator terminals 20 (S522b). Thereafter, when an operation instruction to start monitoring is acquired in the operator terminal 20 that has received the assistance request (S501), the operator terminal 20 transitions to the monitoring mode (S502). Note that, in a case where a monitoring request is also made from the side of the vehicle 46, since the vehicle 46 is online, the flow of FIG. 15 does not include the processing of S5033. The operator terminal 20 that has transitioned to the monitoring mode transmits, to the server 30, a monitoring start instruction for the vehicle 46 (S504). Furthermore, the server 30 that has received this transmits the monitoring start instruction from the operator terminal 20 to the edge device 40 that controls the corresponding vehicle 46 (S505). Here, since steps of S506 to S510 are similar to those in FIG. 10, description thereof will be omitted. The operator terminal 20 that has received the OK response related to the transition of the monitoring mode from the server 30 switches the screen display to the display during monitoring, similarly to the flow of FIG. 14 (S511b).

Note that when a monitoring request is made from the side of the vehicle 46 or an assistance request from the edge device 40 is made, any one operator terminal 20 among the operator terminals 20 in remote viewing for the target vehicle 46 may be automatically transitioned to the monitoring mode.

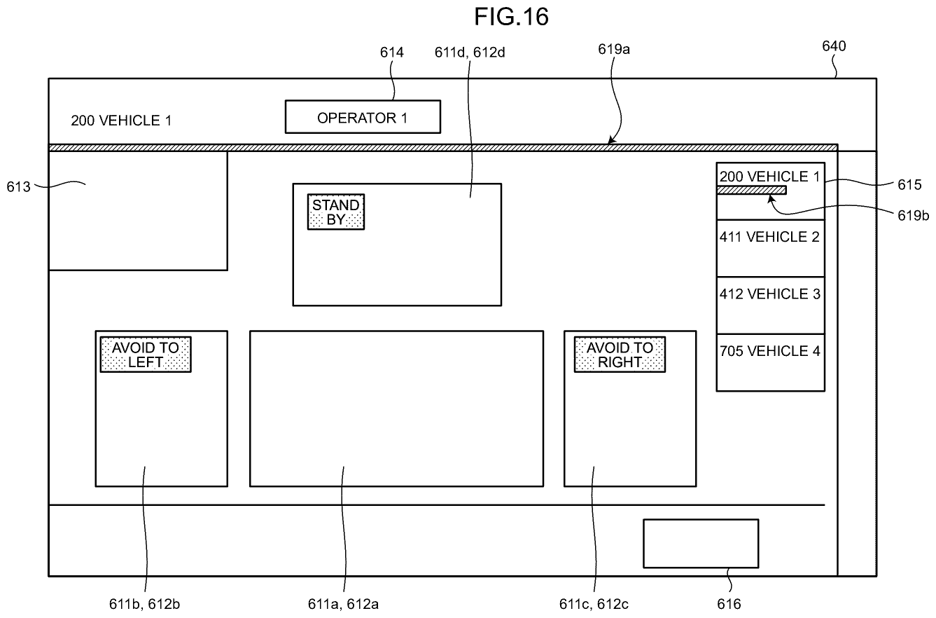

Note that, in the screen display of remote control according to the above-described embodiment (see FIGS. 8 to 9), the monitoring level displays 619a and 619b may be performed. FIG. 16 is a diagram illustrating another example of the screen display of the operator terminal 20 in the remote control according to the embodiment. The display screen 640 of FIG. 16 is an example of a screen display presented to the operator on the operator terminal 20 in the monitoring mode performing remote monitoring. As illustrated in FIG. 16, the display screen 640 includes monitoring level displays 619a and 619b. The monitoring level displays 619a and 619b do not display anything as illustrated in FIGS. 8 and 9 when no operator performs remote monitoring on the vehicle 46 in which the vehicle information is being displayed. On the other hand, when the operator of the own terminal performs remote monitoring on the vehicle 46 in which the vehicle information is being displayed, the operator terminal 20 displays a monitoring level as illustrated in FIG. 16. Here, the monitoring level is information indicating what the operator can do for the vehicle 46 in which the vehicle information is being displayed. As an example, the monitoring level displays 619a and 619b are configured to be distinguishable between a case where the operator can execute an operation instruction of remote assistance and a case where the operator can execute an operation instruction of remote maneuvering by differing display modes such as a color and a shape of the display and a background color.

Note that, in the screen display of remote control according to the above-described embodiment (see FIGS. 8 to 9), options of operation instructions selectable by the operator according to the result of the situation determination may be displayed. When receiving the support request from the vehicle 46, the display screen 640 of FIG. 16 may display vehicle operation instruction buttons 612b to 612d to which other operation instructions are assigned, in addition to the vehicle operation instruction button 612a to which the start/end of traveling is assigned. Note that the number of vehicle operation instruction buttons to which other operation instructions are to be assigned may be two or a plurality of four or more. In the example of FIG. 16, the vehicle operation instruction button 612b to which an operation instruction of “avoid to the left” is assigned is realized by the left image 611b. In addition, the vehicle operation instruction button 612c to which an operation instruction of “avoid to the right” is assigned is realized by the right image 611c. Furthermore, the vehicle operation instruction button 612d to which an operation instruction of “standby” is assigned is realized by the rear image 611d. Note that the number of vehicle operation instruction buttons, the assignment thereof, and the enabled/disabled state may be dynamically changed according to the type of support request (type of support content) from the vehicle 46 and the state of the vehicle 46. Note that, other than the case where the support request is made from the vehicle 46, there may be a case where the operator starts a remote operation instruction even in a situation where the support request from the vehicle 46 does not come, for example, when the operator actively starts monitoring by viewing the screen display of the operator terminal 20 such as a video. In such a case, the number of vehicle operation instruction buttons, the assignment thereof, and the enabled/disabled state can be dynamically changed according to the state of the vehicle 46. Alternatively, in a case where the remote assistance or the remote maneuvering is started in a situation where the support request from the vehicle 46 has not come, the operator may be caused to input the type of the support content, or an option may be presented and the operator may be caused to select the type. Then, the number of vehicle operation instruction buttons, the assignment thereof, and the enabled/disabled state may be dynamically changed according to the type of the support content. That is, the number of vehicle operation instruction buttons, the assignment thereof, and the enabled/disabled state may be dynamically changed according to the type of support content from the vehicle 46 and the state of the vehicle 46.

As an example, when the vehicle 46 is traveling and support is requested with the finding of road parking ahead, the operator terminal 20 may display only the vehicle operation instruction button 612d to which the operation instruction of “standby” is assigned, instead of the vehicle operation instruction button 612a to which the start/end of traveling is assigned. As an example, when the vehicle 46 is stopped and support is requested with the finding of road parking ahead, the operator terminal 20 may display the vehicle operation instruction button 612b to which an operation instruction of “avoid to the left” is assigned and the vehicle operation instruction button 612c to which an operation instruction of “avoid to the right” is assigned, in addition to the vehicle operation instruction button 612a to which the start/end of traveling is assigned. As an example, when support is requested with the presence of a pedestrian crossing in front of the vehicle 46, the operator terminal 20 may display only the vehicle operation instruction button 612a to which the start/end of traveling is assigned.

Note that in the above-described embodiment, the camera video is exemplified as the vehicle information to which the transmission information is attached, but this is not the sole case. As an example, the edge device 40 may attach the transmission information to other vehicle information of the camera video such as information indicating whether the vehicle 46 that is not monitored by the video is in the automatic traveling (information of the vehicle system state). That is, the operator terminal 20 may return the transmission information attached to the camera video for the vehicle 46 that is monitored by the video, and may return the transmission information attached to other information (e.g., information of the vehicle system state) of the camera video for the vehicle 46 that is not monitored by the video. Note that which information is to be used as the information to which the transmission information is attached may be changed depending on the display state of the UI such as whether the camera video is displayed on the operator terminal 20.

Note that each of the above-described modified examples can be arbitrarily combined.

As described above, the remote control according to the present embodiment can clarify the driving responsibility of the operator and reliably perform the operation of the operation instruction by implementing the monitoring mode. That is, according to the remote control according to the present embodiment, the safety of the remote control for automatic driving mobility can be improved.

Note that some or all of the functions of each device (operator terminal 20, controller 25, server 30, edge device 40, and vehicle 46) of the remote control system 1 according to the present disclosure described above may be realized by another device of the remote control system 1.

Note that, in the above-described embodiment, the determination of “whether or not it is A” may be realized by determining only “A”, may be realized by determining only “not A”, or may be realized by determining both of them.

Note that in the above-described embodiment, “any of A” means “at least one of A”.

Note that the program executed by each device of the remote control system 1 according to the above-described embodiment may be provided by being recorded in a computer-readable non-transitory recording medium such as a CD-ROM, an FD, a CD-R, or a DVD as a file in an installable format or an executable format.

In addition, the program executed by each device of the remote control system 1 according to the above-described embodiment may be stored on a computer connected to a network such as the Internet and provided by being downloaded via the network. In addition, the program executed by each device of the remote control system 1 according to the above-described embodiment may be provided or distributed via a network such as the Internet.

In addition, the program executed by each device of the remote control system 1 according to the above-described embodiment may be provided by being incorporated in a ROM or the like in advance.

According to at least one embodiment described above, safety of remote control for automatic driving mobility can be improved.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### Supplementary Notes

The following technologies are disclosed by the above description of the embodiments.
(1)

An information processing method executed by an information processing system configured to support remote control of at least one autonomous moving body by an operator, the information processing method including: by an operator side of the information processing system,
when acquiring an operation instruction to start remote monitoring, transitioning from a viewing mode in which the operator is not responsible for control to a monitoring mode in which the operator is responsible for control and enabling input of an operation instruction of a remote operation for remotely controlling a target moving body that is a target of the remote monitoring among the at least one autonomous moving body; and
when acquiring an operation instruction to end the remote monitoring, transitioning from the monitoring mode to the viewing mode and disabling the input of the operation instruction of the remote operation.
(2)

the information processing method according to (1), in which
the viewing mode is a mode of the remote control for presenting moving body information related to the at least one autonomous moving body to the operator in a remotely viewable manner.
(3)

The information processing method according to (1) or (2), in which
the monitoring mode is a mode of the remote control including a first transmission mode for remotely controlling the target moving body by transmitting a single control signal corresponding to the operation instruction of the remote operation to the target moving body.
(4)

The information processing method according to any one of (1) to (3), in which
the monitoring mode is a mode of the remote control including a second transmission mode for remotely controlling the target moving body by transmitting a continuous control signal corresponding to the operation instruction of the remote operation to the target moving body.
(5)

The information processing method according to any one of (1) to (4), in which
the operation instruction of the remote operation includes at least one operation instruction of a travel start and a travel stop with respect to the target moving body by the operator.
(6)

The information processing method according to any one of (1) to (5), including:
by a target moving body side of the information processing system, attaching transmission information to moving body information related to the target moving body and transmitting it at a predetermined cycle to at least one operator side;
by the operator side, when acquiring operation instruction of the remote operation in the monitoring mode, attaching the transmission information attached to the moving body information from the target moving body side to a control signal corresponding to the acquired operation instruction of the remote operation and returning it to the target moving body side; and
by the target moving body side, calculating, using transmission/reception time of the transmission information, a round-trip delay time including a response time of the operator from when the moving body information is presented to the operator to when an operation instruction of the remote operation of the operator based on the moving body information is executed, and executing control of the target moving body according to the control signal from the operator side when the round-trip delay time is within a predetermined time defined in advance.
(7)

The information processing method according to (6), including
by the target moving body side, disallowing control of the target moving body according to the control signal from the operator side and executing a preset measure for automatically transitioning the target moving body to a safe state when the round-trip delay time exceeds a predetermined time defined in advance.
(8)

The information processing method according to (6) or (7), including
by the target moving body side, rejecting a control signal corresponding to an operation instruction of the remote operation from a second operator side other than the operator side having transitioned to the monitoring mode.
(9)

The information processing method according to any one of (1) to (8), including:
by a target moving body side of the information processing system, attaching transmission information to moving body information related to the target moving body and transmitting it at a predetermined cycle to at least one operator side;
by the operator side, periodically returning the transmission information attached to the moving body information from the target moving body side to the target moving body side in the monitoring mode; and
by the target moving body side, calculating, using transmission/reception time of the transmission information, an expected round-trip delay time including an expected response time from when the moving body information is presented to the operator to when the operation instruction of the remote operation of the operator based on the moving body information is executed, and executing a preset measure for automatically transitioning the target moving body to a safe state when the expected round-trip delay time exceeds a predetermined time defined in advance.
(10)

The information processing method according to (9), including
by the target moving body side, refraining from executing the preset measure based on the expected round-trip delay time for a second operator side other than the operator side having transitioned to the monitoring mode.
(11)

The information processing method according to any one of (1) to (10), including:
by a server configured to relay transmission/reception of information between the target moving body side of the information processing system or each of at least one autonomous moving body side and at least one operator side, limiting an operator side to be transitioned to the monitoring mode with respect to the target moving body to any one operator side among the at least one operator side; and
by second operator side other than the operator side having transitioned to the monitoring mode, disabling an input of an operation instruction to start the remote monitoring related to the target moving body.
(12)

The information processing method according to any one of (1) to (11), including
by the operator side of the information processing system, disabling an input of an operation instruction to end the remote monitoring related to the target moving body when the target moving body is traveling in the monitoring mode.
(13)

The information processing method according to any one of (1) to (11), including
by the operator side of the information processing system, presenting a confirmation notification for preventing erroneous operation to the operator when acquiring an operation instruction to end the remote monitoring related to the target moving body while the target moving body is traveling in the monitoring mode.
(14)

The information processing method according to (12) or (13), in which
when the target moving body is traveling is a state in which speed of the target moving body is not zero or a state in which an automatic traveling system holds an operation right of the target moving body.
(15)

The information processing method according to any one of (1) to (14), including
by the target moving body side of the information processing system, canceling the monitoring mode when a driver directly operates the target moving body and/or an automatic driving system of the target moving body.
(16)

The information processing method according to any one of (1) to (15), including
by the operator side of the information processing system, prohibiting, in the monitoring mode, an input other than an input of an operation instruction to end the remote monitoring related to the target moving body and an input of an operation instruction of the remote operation.
(17)

The information processing method according to any one of (1) to (16), including
by at least one operator side of the information processing system, presenting operator information together with the target moving body of the operator side having transitioned to the monitoring mode, the operator information indicating the operator whose operation is acquired by the operator side having transitioned to the monitoring mode.
(18)

The information processing method according to any one of (1) to (17), including:
by each of at least one operator side of the information processing system, waiting for reception of an assistance request from the target moving body; and
by the target moving body, transmitting the assistance request to the operator side when traveling cannot be continued or when an instruction of the operator is necessary.
(19)

The information processing method according to any one of (1) to (18), including
by the operator side, changing, according to a state of the target moving body and/or a type of support content with respect to the target moving body, any of a number of at least one remote operation button for inputting an operation instruction of the remote operation in the monitoring mode, assignment of an operation instruction to be acquired, and an enabled/disabled state.
(20)

An information processing device configured to realize an operator side in an information processing system configured to support remote control of at least one autonomous moving body by an operator, the information processing device being configured to:
when acquiring an operation instruction to start remote monitoring, transition from a viewing mode in which the operator is not responsible for control to a monitoring mode in which the operator is responsible for control and enable input of an operation instruction of a remote operation for remotely controlling a target moving body that is a target of the remote monitoring among the at least one autonomous moving body; and
when acquiring an operation instruction to end the remote monitoring, transition from the monitoring mode to the viewing mode and disable the input of the operation instruction of the remote operation.
(21)

A program for causing a computer configured to realize an operator side in an information processing system configured to support remote control of at least one autonomous moving body by an operator, to execute,
when acquiring an operation instruction to start remote monitoring, transitioning from a viewing mode in which the operator is not responsible for control to a monitoring mode in which the operator is responsible for control and enabling input of an operation instruction of a remote operation for remotely controlling a target moving body that is a target of the remote monitoring among the at least one autonomous moving body; and
when acquiring an operation instruction to end the remote monitoring, transitioning from the monitoring mode to the viewing mode and disabling the input of the operation instruction of the remote operation.
(22)

An information processing device including:
at least one processor; and
at least one memory; in which
the at least one processor executes the information processing method according to any one of (1) to (19) by executing a program stored in the at least one memory.
(23)

A program or a computer-readable non-transitory storage medium storing the program, the program causing a computer to execute the information processing method according to any one of (1) to (19).

What is claimed is:

1. An information processing method executed by an information processing system configured to support remote control of at least one autonomous moving body by an operator, the information processing method comprising: by an operator side of the information processing system,
when acquiring an operation instruction to start remote monitoring, transitioning from a viewing mode in which the operator is not responsible for control to a monitoring mode in which the operator is responsible for control and enabling input of an operation instruction of a remote operation for remotely controlling a target moving body that is a target of the remote monitoring among the at least one autonomous moving body; and
when acquiring an operation instruction to end the remote monitoring, transitioning from the monitoring mode to the viewing mode and disabling the input of the operation instruction of the remote operation.

2. The information processing method according to claim 1, wherein
the viewing mode is a mode of the remote control for presenting moving body information related to the at least one autonomous moving body to the operator in a remotely viewable manner.

3. The information processing method according to claim 1, wherein
the monitoring mode is a mode of the remote control including a first transmission mode for remotely controlling the target moving body by transmitting a single control signal corresponding to the operation instruction of the remote operation to the target moving body.

4. The information processing method according to claim 1, wherein
the monitoring mode is a mode of the remote control including a second transmission mode for remotely controlling the target moving body by transmitting a continuous control signal corresponding to the operation instruction of the remote operation to the target moving body.

5. The information processing method according to claim 1, wherein
the operation instruction of the remote operation includes at least one operation instruction of a travel start and a travel stop with respect to the target moving body by the operator.

6. The information processing method according to claim 1, comprising:
by a target moving body side of the information processing system, attaching transmission information to moving body information related to the target moving body and transmitting it at a predetermined cycle to at least one operator side;
by the operator side, when acquiring operation instruction of the remote operation in the monitoring mode, attaching the transmission information attached to the moving body information from the target moving body side to a control signal corresponding to the acquired operation instruction of the remote operation and returning it to the target moving body side; and
by the target moving body side, calculating, using transmission/reception time of the transmission information, a round-trip delay time including a response time of the operator from when the moving body information is presented to the operator to when an operation instruction of the remote operation of the operator based on the moving body information is executed, and executing control of the target moving body according to the control signal from the operator side when the round-trip delay time is within a predetermined time defined in advance.

7. The information processing method according to claim 6, comprising
by the target moving body side, disallowing control of the target moving body according to the control signal from the operator side and executing a preset measure for automatically transitioning the target moving body to a safe state when the round-trip delay time exceeds a predetermined time defined in advance.

8. The information processing method according to claim 6, comprising
by the target moving body side, rejecting a control signal corresponding to an operation instruction of the remote operation from a second operator side other than the operator side having transitioned to the monitoring mode.

9. The information processing method according to claim 1, comprising:
by a target moving body side of the information processing system, attaching transmission information to moving body information related to the target moving body and transmitting it at a predetermined cycle to at least one operator side;
by the operator side, periodically returning the transmission information attached to the moving body information from the target moving body side to the target moving body side in the monitoring mode; and
by the target moving body side, calculating, using transmission/reception time of the transmission information, an expected round-trip delay time including an expected response time from when the moving body information is presented to the operator to when the operation instruction of the remote operation of the operator based on the moving body information is executed, and executing a preset measure for automatically transitioning the target moving body to a safe state when the expected round-trip delay time exceeds a predetermined time defined in advance.

10. The information processing method according to claim 9, comprising
by the target moving body side, refraining from executing the preset measure based on the expected round-trip delay time for a second operator side other than the operator side having transitioned to the monitoring mode.

11. The information processing method according to claim 1, comprising:
by a server configured to relay transmission/reception of information between the target moving body side of the information processing system or each of at least one autonomous moving body side and at least one operator side, limiting an operator side to be transitioned to the monitoring mode with respect to the target moving body to any one operator side among the at least one operator side; and
by second operator side other than the operator side having transitioned to the monitoring mode, disabling an input of an operation instruction to start the remote monitoring related to the target moving body.

12. The information processing method according to claim 1, comprising
by the operator side of the information processing system, disabling an input of an operation instruction to end the remote monitoring related to the target moving body when the target moving body is traveling in the monitoring mode.

13. The information processing method according to claim 1, comprising
by the operator side of the information processing system, presenting a confirmation notification for preventing erroneous operation to the operator when acquiring an operation instruction to end the remote monitoring related to the target moving body while the target moving body is traveling in the monitoring mode.

14. The information processing method according to claim 12, wherein
when the target moving body is traveling is a state in which speed of the target moving body is not zero or a state in which an automatic traveling system holds an operation right of the target moving body.

15. The information processing method according to claim 1, comprising
by the target moving body side of the information processing system, canceling the monitoring mode when a driver directly operates the target moving body and/or an automatic driving system of the target moving body.

16. The information processing method according to claim 1, comprising
by the operator side of the information processing system, prohibiting, in the monitoring mode, an input other than an input of an operation instruction to end the remote monitoring related to the target moving body and an input of an operation instruction of the remote operation.

17. The information processing method according to claim 1, comprising
by at least one operator side of the information processing system, presenting operator information together with the target moving body of the operator side having transitioned to the monitoring mode, the operator information indicating the operator whose operation is acquired by the operator side having transitioned to the monitoring mode.

18. The information processing method according to claim 1, comprising:
by each of at least one operator side of the information processing system, waiting for reception of an assistance request from the target moving body; and
by the target moving body, transmitting the assistance request to the operator side when traveling cannot be continued or when an instruction of the operator is necessary.

19. An information processing device configured to realize an operator side in an information processing system configured to support remote control of at least one autonomous moving body by an operator, the information processing device being configured to:
when acquiring an operation instruction to start remote monitoring, transition from a viewing mode in which the operator is not responsible for control to a monitoring mode in which the operator is responsible for control and enable input of an operation instruction of a remote operation for remotely controlling a target moving body that is a target of the remote monitoring among the at least one autonomous moving body; and
when acquiring an operation instruction to end the remote monitoring, transition from the monitoring mode to the viewing mode and disable the input of the operation instruction of the remote operation.

20. A computer program product comprising a computer-readable medium including programmed instructions that cause a computer configured to realize an operator side in an information processing system configured to support remote control of at least one autonomous moving body by an operator, to execute,
when acquiring an operation instruction to start remote monitoring, transitioning from a viewing mode in which the operator is not responsible for control to a monitoring mode in which the operator is responsible for control and enabling input of an operation instruction of a remote operation for remotely controlling a target moving body that is a target of the remote monitoring among the at least one autonomous moving body; and
when acquiring an operation instruction to end the remote monitoring, transitioning from the monitoring mode to the viewing mode and disabling the input of the operation instruction of the remote operation.
